(19) United States
(12) Patent Application Publication
(10) Pub. No.: US 2024/0249210 A1
(43) Pub. Date: Jul. 25, 2024

(54) HOUSEWORK POINT CALCULATION METHOD, INFORMATION PROCESSING DEVICE, AND COMPUTER-READABLE RECORDING MEDIUM RECORDING A PROGRAM

(71) Applicant: Panasonic Intellectual Property Corporation of America, Torrance, CA (US)

(72) Inventors: Hirokazu KITO, Osaka (JP); Atsushi NISHIMURA, Osaka (JP); Masataka UEMURA, Nara (JP)

(73) Assignee: Panasonic Intellectual Property Corporation of America, Torrance, CA (US)

(21) Appl. No.: 18/626,982

(22) Filed: Apr. 4, 2024

Related U.S. Application Data
(63) Continuation of application No. PCT/JP2022/037581, filed on Oct. 7, 2022.

(30) Foreign Application Priority Data
Oct. 7, 2021 (JP) 2021-165641

(51) Int. Cl. G06Q 10/0631

(52) U.S. Cl. CPC G06Q 10/0631

(57) ABSTRACT

An information processing device performs: acquiring use information indicating a use situation of an appliance or a facility; collecting household job data of a user on the basis of the use information; acquiring third party coefficient information indicating a third party coefficient set by a third party different from the user; and calculating, on the basis of the household job data and the third party coefficient information, a household job point that is commensurate with a household job amount of the user.

### FIELD OF INVENTION

The present disclosure relates to a household job point calculation method, an information processing device, and a computer-readable recording medium recording a program.

### BACKGROUND ART

Patent Literature 1 discloses a user management method including expressing a full use level in connection with an appliance at a numeric value and providing a user having a higher full use level with a predetermined service to give the user an incentive to make full use of the appliance.

However, the user management method disclosed in Patent Literature 1 fails to consider appropriate giving of a household job point that is commensurate with a household job amount to a user with an aim of giving the user an incentive to do a household job.

Patent Literature 1: Japanese Patent Publication No. 6161624

### SUMMARY OF THE INVENTION

This disclosure has an object of providing a household job point calculation method, an information processing device, and a computer-readable recording medium recording a program for appropriately giving a user a household job point that is commensurate with a household job amount of the user and that meets a request from a third party.

A household job point calculation method according to one aspect of the present disclosure includes: by an information processing device, acquiring use information indicating a use situation of an appliance or a facility; collecting household job data of a user on the basis of the use information; acquiring third party coefficient information indicating a third party coefficient set by a third party different from the user; and calculating, on the basis of the household job data and the third party coefficient information, a household job point that is commensurate with a household job amount of the user.

### BRIEF DESCRIPTION OF THE DRAWINGS

FIG. 1 is a simplified diagram showing an overall configuration of a home control system in an embodiment of the present disclosure.

FIG. 2 is a flowchart schematically showing a sequence of a process executed by a controller.

FIG. 3 is a table showing an example of simplified use information.

FIG. 4 is a table showing simplified household job data in a first example.

FIG. 5 is a table showing simplified household job data in a second example.

FIG. 6 is a table showing an example of simplified household job point information generated only on the basis of household job data.

FIG. 7 is a table showing an example of simplified manufacturer coefficient information.

FIG. 8 is a table showing an example of simplified household job point information generated on the basis of the household job data and the manufacturer coefficient information.

FIG. 9 is a simplified diagram showing an overall configuration of a home control system in a third modification.

FIG. 10 is a table showing an example of simplified user coefficient information.

FIG. 11 is a simplified diagram showing an overall configuration of a home control system in a fourth modification.

FIG. 12 is a table showing an example of simplified attribute coefficient information.

FIG. 13 is a schematic view of a feature of the disclosure.

### DETAILED DESCRIPTION

### Knowledge Forming the Basis of the Present Disclosure

A group, such as a family, involves jobs like household jobs to be shared and executed among a plurality of users. In a general family, it is difficult to accumulate a household job amount about the household job execution by each of the users as data, and thus, the amount is less likely to be visualized. Under the circumstances without the visualization of the household job amount, each user can grasp only his/her own household job amount, and thus, the users may feel stress resulting from distrust or unfairness thereamong. An improvement in the visualization of the household job amount is expected to reduce the stress feeling of each user. The improvement in the visualization of the household job amount is further expected to give each user a reward that is commensurate with the household job amount of the user as a household job point, resulting in exerting an effect of giving the user an incentive to do the household job.

In addition, a manufacturer of an appliance or a facility has a request or demand for wide spreading of its own products.

To meet the expectation and the demand or overcome the drawbacks, the present inventors have obtained the knowledge that a household job point that is commensurate with a household job amount of a user and a third party coefficient can be appropriately given to the user by collecting household job data of the user on the basis of use information about an appliance or a facility and calculating the household job point on the basis of the household job data and the third party coefficient, the third party coefficient being set in connection with a third party like a manufacturer of the appliance or the facility in advance. The present inventors have conceived of a feature of the disclosure with this knowledge.

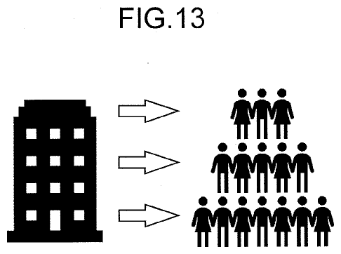

FIG. 13 is a schematic view of a feature of the disclosure. Each of a plurality of users serving as household job executers is given a third party coefficient in connection with a third party different from each household job executer. In FIG. 13, each human shape indicates a user, and a building shape indicates a third party, and each arrow extending from the third party to the user indicates setting of the third coefficient in connection with the third party for each user. The third party includes a manufacturer of an appliance or a facility. Alternatively, the third party includes a data analysist or a marketer. A household job point for the user is calculated on the basis of household job data of the user and the third party coefficient.

Hereinafter, features of the present disclosure will be described.

A household job point calculation method according to a first feature of the present disclosure includes: by an information processing device, acquiring use information indicating a use situation of an appliance or a facility; collecting household job data of a user on the basis of the use information; acquiring third party coefficient information indicating a third party coefficient set by a third party different from the user; and calculating, on the basis of the household job data and the third party coefficient information, a household job point that is commensurate with a household job amount of the user.

In the first feature, a household job point that is commensurate with a household job amount of a user and that meets a request from a third party can be appropriately given to the user.

With a household job point calculation method according to a second feature of the disclosure, in the first feature, the third party may include a manufacturer of an appliance or a facility.

The second feature enables use of the third party coefficient in connection with the manufacturer of an appliance or a facility in the calculation of the household job point.

With a household job point calculation method according to a third feature of the disclosure, in the second feature, the information processing device may further set a third party coefficient for a user who uses an appliance or a facility manufactured by a specific manufacturer to be larger than a third party coefficient for a user who uses an appliance or a facility manufactured by another manufacturer.

The third feature enables wide spreading of an appliance or a facility manufactured by a specific manufacturer.

With a household job point calculation method according to a fourth feature of the disclosure, in the second or third feature, the information processing device may further set a third party coefficient for a user who uses a first number of appliances or facilities manufactured by the specific manufacturer to be larger than a third party coefficient for a user who uses a second number of appliances or facilities manufactured by the specific manufacturer, the second number being smaller than the first number.

The fourth feature enables further wide spreading of an appliance or a facility manufactured by the specific manufacturer.

With a household job point calculation method according to a fifth feature of the disclosure, in any one of the second to fourth features, the information processing device may further set a third party coefficient for a user who uses an appliance or a facility manufactured by the specific manufacturer on a first manufacture date to be larger than a third party coefficient for a user who uses an appliance or a facility manufactured by the specific manufacturer on a second manufacture date earlier than the first manufacture date.

The fifth feature enables wide spreading of a new product of an appliance or a facility manufactured by the specific user.

With a household job point calculation method according to a sixth feature of the disclosure, in any one of the first to fifth features, the information processing device may further acquire user coefficient information indicating a user coefficient for a user, and calculate the household job point on the basis of the household job data, the third party coefficient information, and the user coefficient information.

In the sixth feature, a household job point that is commensurate with a household job amount of the user can be appropriately given to the user.

With a household job point calculation method according to a seventh feature of the disclosure, in any one of the first to sixth features, the information processing device may further acquire attribute coefficient information indicating an attribute coefficient in connection with an attribute of a user, and calculate the household job point on the basis of the household job data, the third party coefficient information, and the attribute coefficient information.

In the seventh feature, a household job point that is commensurate with an attribute of the user can be appropriately given to the user.

With a household job point calculation method according to an eighth feature of the disclosure, in any one of the first to seventh features, the information processing device may further acquire, from a specific user, change information indicating a change in the third party coefficient, and change the third party coefficient on the basis of the change information.

The eighth feature enables an appropriate change in the third party coefficient by the specific user.

With a household job point calculation method according to a ninth feature of the disclosure, in the eighth feature, the information processing device may further set the specific user on the basis of household job data of a plurality of users in a predetermined period.

The ninth feature permits a user having the largest household job amount in a predetermined period to have a change authority to change the third party coefficient.

An information processing device according to a tenth feature of the present disclosure includes: an acquisition part; and a processing part. The acquisition part acquires use information indicating a use situation of an appliance or a facility, the processing part collects household job data of a user on the basis of the use information, the acquisition part acquires third party coefficient information indicating a third party coefficient set by a third party different from the user, and the processing part calculates, on the basis of the household job data and the third party coefficient information, a household job point that is commensurate with a household job amount of the user.

In the tenth feature, a household job point that is commensurate with a household job amount of the user and that meets a request from a third party can be appropriately given to the user.

A computer-readable recording medium recording a program according to an eleventh feature of the present disclosure causing an information processing device to serve as an acquisition part and a processing part. The acquisition part acquires use information indicating a use situation of an appliance or a facility, the processing part collects household job data of a user on the basis of the use information, the acquisition part acquires third party coefficient information indicating a third party coefficient set by a third party different from a user, and the processing part calculates, on the basis of the household job data and the third party coefficient information, a household job point that is commensurate with a household job amount of the user.

In the eleventh feature, a household job point that is commensurate with a household job amount of the user and that meets a request from a third party can be appropriately given to the user.

This disclosure can be realized as a program for causing a computer to execute each distinctive feature included in such a method or a device described above, or realized as a system caused to operate by the program. Additionally, it goes without saying that the computer program is distributable as a non-transitory computer readable storage medium like a CD-ROM, or distributable via a communication network like the Internet.

### Embodiment of the Present Disclosure

Hereinafter, an embodiment of the disclosure will be described with reference to the accompanying drawings. The elements given the same reference numerals in different drawings are defined to be the same or corresponding elements. Further, constituent elements, arrangement and connection of the constituent elements, an operation order, and the like shown in the embodiment described below are mere examples, and do not intend to limit the present disclosure. The present disclosure is defined by the scope of claims. Moreover, constituent elements which are not recited in the independent claims each showing the broadest concept among the constituent elements in the embodiment are not indispensable to achieve the object of the present disclosure but are described as selectable constituent elements.

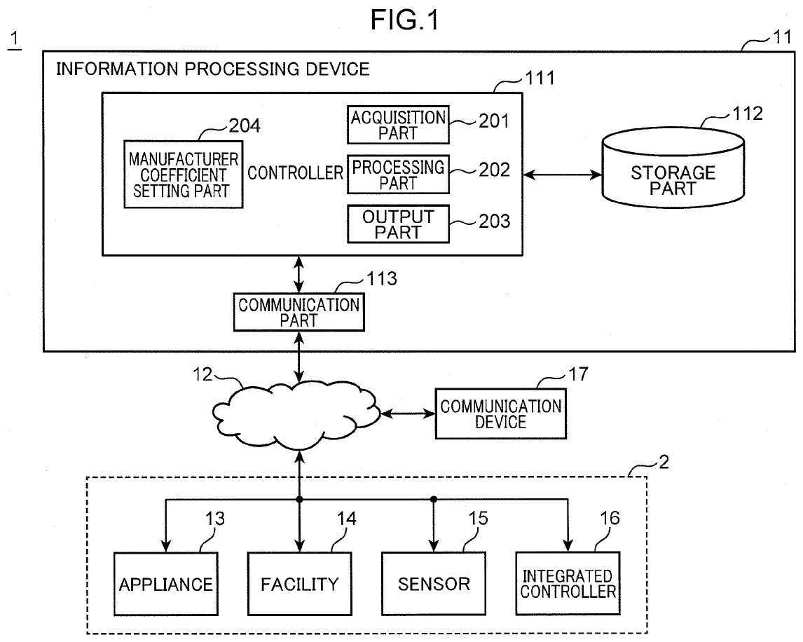

FIG. 1 is a simplified diagram showing an overall configuration of a home control system 1 in an embodiment of the present disclosure. The home control system 1 includes; an information processing device 11; a communication device 17; and an appliance 13, a facility 14, a sensor 15, and an integrated controller 16 each provided in the smart home 2. A plurality of appliances 13, facilities 14, and sensors 15 may be provided. In the description below, the smart home 2 is defined to include a plurality of appliances 13, a plurality of facilities 14, and a plurality of sensors 15 provided therein. Although FIG. 1 shows only one smart home 2 for simplified explanation, a plurality of smart homes 2 may be included. The present disclosure is applicable to an indoor facility, such as an office, a restaurant, and a commercial facility, without limitation to a residence like the smart home 2. This disclosure may be further applicable to a space including an indoor space and an outdoor space without limitation to such an indoor facility.

The smart home 2 includes a plurality of spaces or rooms including a room or chamber, a bathroom, a toilet room, an entrance, and a hallway, where the appliances 13 and the facilities 14 are arranged. The appliances 13 include an electric cooker, a refrigerator, a washing machine, and a toilet cleansing device. The facilities 14 include water supply equipment, like a tap or faucet, and a shower device, provided in a kitchen or the bathroom.

The smart home 2 is further provided with the plurality of sensors 15. The sensors 15 include a microphone, an infrared sensor, an ultrasonic sensor, a fingerprint sensor, an iris sensor, or a camera. Each sensor 15 may be included in the appliance 13 or the facility 14, or may be provided independently of the appliance 13 or the facility 14. The sensor 15 detects an execution situation of a household job in the smart home 2, and sends sensing information obtained through the detection to the information processing device 11 via the communication network 12. The communication network 12 includes an appropriate communication network, such as a special circuit network or a public switched telephone network. The sensing information includes information for specifying a user using the appliance 13 or the facility 14. For instance, when the sensor 15 is a camera, the sensing information includes image data of the user captured by the camera. The information processing device 11 includes a processing part 202 that specifies a user using an appliance 13 or a facility 14 by collating a face image of the user contained in the sensing information with a template image of a face of each of a plurality of users stored in a storage part 112 in advance. The information processing device 11 or the sensor 15 may specify the user on the basis of the sensing information. When use information 20 to be described later includes user information 23 in accordance with a preliminary input of a user ID in use of the appliance 13 or the facility 14, the acquisition of the sensing information from the sensor 15 is excludable.

The smart home 2 is further provided with the integrated controller 16 to control an operation of an appliance 13 or a facility 14 to be controlled among the appliances 13 or the facilities 14. The integrated controller 16 can perform data communication with the appliance 13 or the facility 14 to be controlled via the communication network 12 or a wireless LAN in the smart home 2.

The communication device 17 includes smart phones respectively owned by users living in the smart home 2.

The information processing device 11 includes a cloud server or an edge server to manage an entirety of the home control system 1. The information processing device 11 can perform data communication with the communication device 17, the integrated controller 16, the appliance 13, the facility 14, or the sensor 15 via the communication network 12. The integrated controller 16 may include the functions of the information processing device 11.

The information processing device 11 includes a controller 111, the storage part 112, and a communication part 113. The controller 111 includes a processor, such as a CPU. The storage part 112 includes an HDD, an SSD, a flush memory, or other memory. The communication part 113 includes a communication module suitable for the communication protocol of the communication network 12, such as the IP.

The controller 111 operatively includes an acquisition part 201, a processing part 202, an output part 203, and a manufacturer coefficient setting part 204 each coming into effect when a CPU executes a program read to a ROM or a RAM from a storage part 112. In other words, the program causes the information processing device 11 to serve as the acquisition part 201, the processing part 202, the output part 203, and the manufacturer coefficient setting part 204. The acquisition part 201 acquires use information 20 indicating a history of a use situation of an appliance 13 or a facility 14 from the appliance 13 or the facility 14 via the communication network 12 and the communication part 113. The acquisition part 201 further acquires, from the storage part 112, manufacturer coefficient information 50 indicating a manufacturer coefficient in connection with a manufacturer of the appliance 13 or the facility 14. The manufacturer coefficient information 50 is set by the manufacturer coefficient setting part 204 in advance, and stored in the storage part 112. The processing part 202 collects household job data 31 of each of a plurality of users on the basis of management information to be described later and on the basis of the use information 20 acquired by the acquisition part 201. The processing part 202 further calculates a household job point that is commensurate with a household job amount of each of the users on the basis of the household job data 31 and the manufacturer coefficient information 50 acquired by the acquisition part 201 to generate household job point information 42. The output part 203 outputs the household job point information 42 generated by the processing part 202. The household job point information 42 output by the output part 203 is stored in the storage part 112 and transmitted to the communication device 17 via the communication part 113 and the communication network 12.

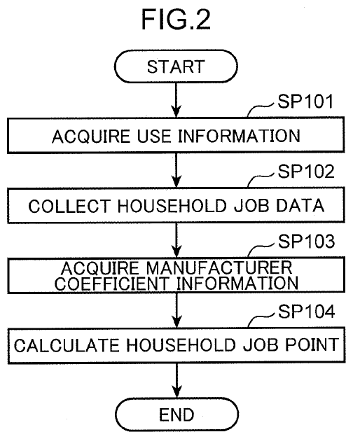

FIG. 2 is a flowchart schematically showing a sequence of a process executed by the controller 111.

First, in step SP101, the acquisition part 201 acquires use information 20 indicating a use situation of an appliance 13 or a facility 14 from the appliance 13 or the facility 14 via the communication network 12 and the communication part 113. Specifically, the use information 20 stored in the storage part 112 represents a database including a plurality of records, and the acquisition part 201 acquires each record associated with each manipulation of the appliance 13 or the facility 14. The record of the use information 20 may be acquired in real time, or at equal time intervals. The acquisition part 201 stores the acquired record of the use information 20 in the storage part 112.

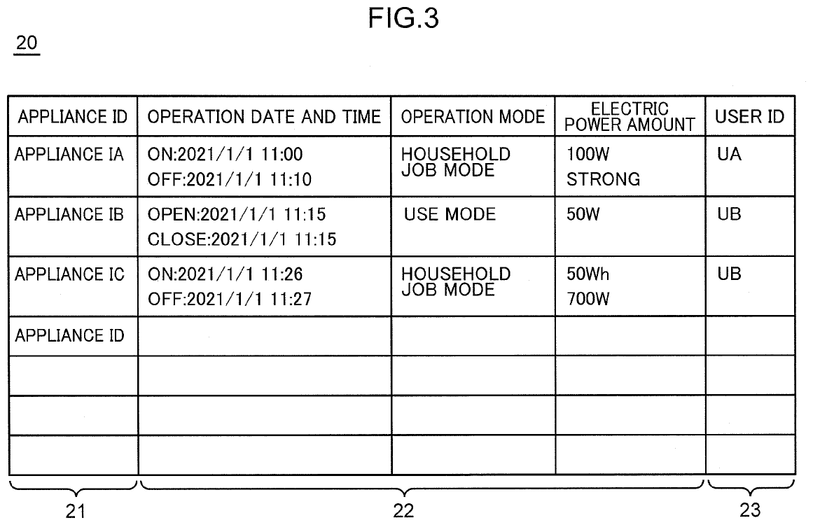

FIG. 3 is a table showing an example of simplified use information 20. The use information 20 includes appliance information 21, operating information 22, and the user information 23. Although FIG. 3 shows use information 20 about appliances 13, this is similarly applicable to facilities 14. The use information 20 represents a database including a plurality of records, and each record is associated with once manipulation of the appliance 13 or the facility 14. Each record includes a filed for the appliance information 21, a field for the operating information 22, and a field for the user information 23.

The appliance information 21 includes an appliance ID for individually identifying each of the appliances 13. In a case where there is only one appliance 13 to be managed, the appliance information 21 may be omitted.

The operating information 22 includes operation date and time information, operation mode information, and electric power amount information. The operation date and time information includes, for example, information indicating a year, a date, and a time to start an operation of the appliance 13 or the facility 14 (to be “ON”, “OPEN”), and information indicating a year, a date, and a time to finish the operation of the appliance 13 or the facility 14 (to be “OFF”, “CLOSE”). The operation mode information exemplifies setting information at operation, and includes household job mode information (first use information) indicating a household job mode associated with use of the appliance 13 or the facility 14 accompanied by execution of the household job and use mode information (second use information) indicating a use mode associated with use of the appliance 13 or the facility 14 unaccompanied by the execution of the household job. For instance, regarding a shower device in a bathroom, use of the shower device for cleaning the bathroom is directed to the household job mode, and use of the shower device at taking a bath is directed to the use mode. Distinction between the household job mode and the use mode may be made in accordance with an input from the user for a mode setting in use of the appliance 13 or the facility 14, or may be automatically made by the processing part 202 of the information processing device 11 on the basis of timeframe information or a result of detection from the sensor 15. The use information 20 only about the household job mode of the household job mode and the use mode is collected for use in generating the household job data 31, 32 to be described later. The electric power amount information exemplifies operation strength information, and includes a degree of strength or weakness of the appliance 13 or the facility 14, or a power consumption amount thereof. The processing part 202 included in the controller 111 may acquire the electric power amount information from the appliance 13 or the facility 14, or may calculate the electric power amount information on the basis of information acquired from the appliance 13 or the facility 14. For instance, the processing part 202 of the controller 111 calculates the power consumption amount on the basis of an operating time and an operating wattage.

The user information 23 includes a user ID for individually identifying each of the users. Distinction among the users each executing a household job may be made in accordance with an input of a user ID from an associated user in use of the appliance 13 or the facility 14, or may be automatically made by the information processing device 11 on the basis of a result of detection from the sensor 15. Alternatively, the communication device 17 or the integrated controller 16 may be used for a text input or a voice input to receive the input of the user ID after the use.

Subsequently, in step SP102, the processing part 202 collects household job data 31 of each of the users on the basis of management information defining a correspondence between a kind of the appliance 13 or the facility 14 and a content of a household job and on the basis of the use information 20 acquired in step SP101. The management information may include, for example, a household job of washing associated with an appliance ID of an appliance 13 of a washing machine, and a household job of cleaning associated with an appliance ID of another appliance 13 of a cleaner. The processing part 202 uses an appliance ID as key information to associate a household job shown in the management information with a user shown in the use information 20 to calculate a job amount of each user for each household job.

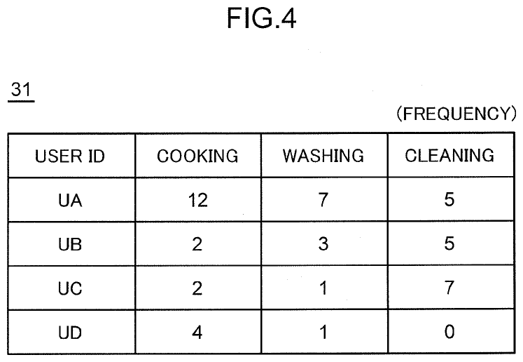

FIG. 4 is a table showing simplified household job data 31 in a first example. In the household job data 31, a household job amount of each of the users in a predetermined period (e.g., one week, one month, or a couple of months) is calculated as a household job execution frequency. For instance, total values of execution frequencies about a user UA having a user ID of “UA” indicate twelve times for cooking, seven times for washing, and five times for cleaning respectively. The processing part 202 counts one execution frequency when a predetermined time period or longer continuously elapses without use of an appliance 13 or a facility 14 after a finish of the use of the appliance 13 or the facility 14 accompanied by execution of a household job. Examples of the predetermined time period include ten minutes, thirty minutes, and one hour. In detection of use of a certain appliance 13 or a certain facility 14 by a plurality of users in a certain timeframe, the processing part 202 may distribute the execution frequency of a relevant household job to the users. For instance, in detection of one execution frequency of a household job using the same appliance 13 or facility 14 by each of the users UA and UB in the morning, the processing part 202 calculates the execution frequency as ½ for each of the users UA and UB.

In the example shown in FIG. 4, the frequency of cooking may be calculated independently for breakfast, lunch, and supper on the basis of timeframe information. Besides, the frequency of cleaning may be calculated on the basis of position information about a cleaner for each room or chamber. Furthermore, when the household job point is calculated on the basis of household job data in step SP104 to be described later, a coefficient which is different depending on a timeframe may be multiplied, or a coefficient which is different depending on a chamber may be multiplied. For instance, a larger coefficient may be set for a timeframe or a chamber with a smaller execution frequency of the household job.

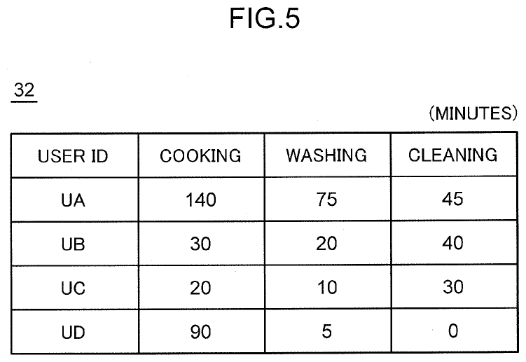

FIG. 5 is a table showing simplified household job data 32 in a second example. In the household job data 32, a household job amount of each of the users is calculated as an execution time (minute) of a household job in a predetermined time period. For instance, total values of execution time about the user having the user ID of “UA” indicate 140 minutes for cooking, 75 minutes for washing, and 45 minutes for cleaning. The processing part 202 can calculate, as a once execution time period, an elapsed time period from an operation start time to an operation finish time contained in the operation date and time information in the use information 20.

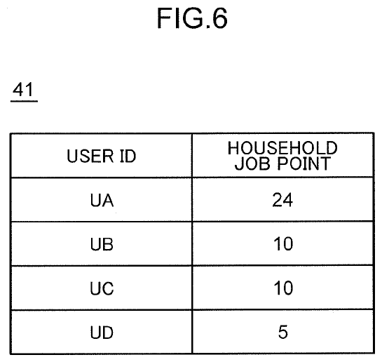

FIG. 6 is a table showing an example of simplified household job point information 41 generated only on the basis of the household job data 31. Regarding the household job point information 41, the household job point for each user is calculated by simple addition of an execution frequency of a household job included in household job data 31 per user. For instance, in the household job data 31 in FIG. 4, total values of execution frequencies about a user UA having a user ID of “UA” indicate twelve times for cooking, seven times for washing, and five times for cleaning respectively. In this respect, regarding the household job point information 41 shown in FIG. 6, a household job point for the user having the user ID of “UA” is calculated to be 12+7+5=24.

Next, in step SP103, the acquisition part 201 acquires, from the storage part 112, manufacturer coefficient information 50 indicating a manufacturer coefficient set by a manufacturer of the appliance 13 or the facility 14.

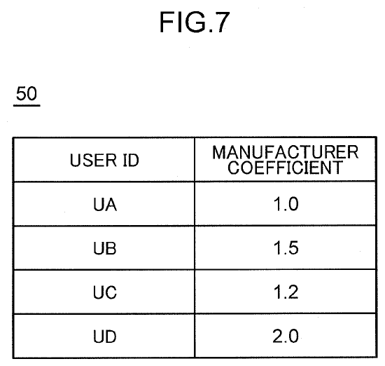

FIG. 7 is a table showing an example of simplified manufacturer coefficient information 50. The manufacturer coefficient setting part 204 sets the manufacturer coefficient information 50 for each user. In the example shown in FIG. 7, manufacturer coefficients are given to respective users in the manner of: “1.0” for the user having the user ID of “UA”, referred to as the “user UA” as well; “1.5” for a user having a user ID of “UB”, referred to as the “user UB” as well; “1.2” for a user having a user ID of “UC”, referred to as the “user UC” as well; and “2.0” for a user having a user ID of “UD”, referred to as “user UD” as well.

As a first example, the manufacturer coefficient setting part 204 sets a manufacturer coefficient in connection with a manufacturer of an appliance 13 or a facility 14. The manufacturer of the appliance 13 or the facility 14 sets a manufacturer coefficient for a user who uses the appliance 13 or the facility 14 manufactured by the manufacturer (referred to as a “specific manufacturer” as well) to be larger than a manufacturer coefficient for a user who uses an appliance 13 or a facility 14 manufactured by another manufacturer. In other words, a user who uses a product of the manufacturer is given a manufacturer coefficient which is larger than a manufacturer coefficient for a user who does not use a product of the manufacturer.

As a second example, the manufacturer coefficient setting part 204 sets a manufacturer coefficient in accordance with a use product number of appliances 13 or facilities 14 manufactured by a specific manufacturer. The manufacturer of an appliance 13 or a facility 14 sets a manufacturer coefficient for a user who uses a first product number of appliances or facilities manufactured by the specific manufacturer to be larger than a manufacturer coefficient for a user who uses a second product number of appliances or facilities manufactured by the specific manufacturer, the second product number being smaller than the first product number. In other words, a user who uses a larger number of products of the specific manufacturer is given a larger manufacturer coefficient.

As a third example, the manufacturer coefficient setting part 204 sets a manufacturer coefficient in accordance with a manufactured date of an appliance 13 or a facility 14 manufactured by a specific manufacturer. The manufacturer of an appliance 13 or a facility 14 sets a manufacturer coefficient for a user who uses an appliance or a facility manufactured by the specific manufacturer on a first manufacture date to be larger than a manufacturer coefficient for a user who uses an appliance or a facility manufactured by the specific manufacturer on a second manufacture date earlier than the first manufacture date. In other words, a user who uses a newer product of the specific manufacturer is given a larger manufacturer coefficient.

As a result of adopting at least one of the first to third examples, manufacturer coefficients “1.0”, “1.5”, “1.2”, and “2.0” are set respectively for the users UA, UB, UC, and UD.

In the example shown in FIG. 7, a user is targeted for a manufacturer coefficient to be given, and thus, the manufacturer coefficient is reflected on household job data associated with all the household jobs executed by the user. A target for giving a manufacturer coefficient may be an appliance 13 or a facility 14 without limitation to this example. In this case, the manufacturer coefficient may be reflected only on household job data associated with a household job executed by each user who uses the appliance 13 or the facility 14.

Moreover, a manufacturer of an appliance 13 or a facility 14 may give a reward to a business or management operator of the system 1 in exchange for more preferential transaction for products of the manufacturer than transaction for products of another manufacturer depending on a setting of a manufacturer coefficient. An upper limit value of a settable manufacturer coefficient may be determined in accordance with an amount of the reward.

A manufacturer of an appliance 13 or a facility 14 may acquire, from the information processing device 11, data of use information 20 acquired in use of a product of the manufacturer. In this case, it is preferable to confirm approval or disapproval from a user about data provision in conformity with terms of use or other rules. The manufacturer of the appliance 13 or the facility 14 may set a manufacturer coefficient for a user having approved of data provision to be larger than a manufacturer coefficient for a user having disapproved of data provision.

Next, in step SP104, the processing part 202 calculates a household job point that is commensurate with a household job amount of each of the users on the basis of the household job data 31 and the manufacturer coefficient information 50 to generate household job point information 42.

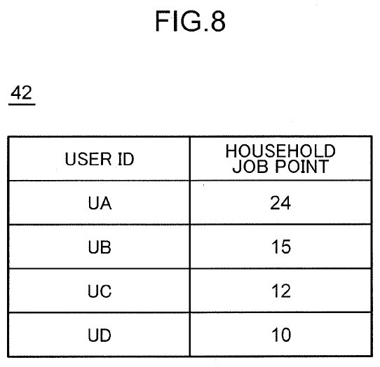

FIG. 8 is a table showing an example of simplified household job point information 42 generated on the basis of the household job data 31 and the manufacturer coefficient information 50. The processing part 202 multiplies the manufacturer coefficient shown in FIG. 7 by the household job point included in the household job point information 41 shown in FIG. 6 to calculate the household job point for each user. For instance, regarding the user UB, the processing part 202 multiplies the manufacturer coefficient “1.5” shown in FIG. 7 by the household job point “10” shown in FIG. 6 to calculate the household job point as “15”.

The output part 203 outputs the household job point information 42 generated by the processing part 202. The household job point information 42 output by the output part 203 is stored in the storage part 112 and transmitted to the communication device 17 via the communication part 113 and the communication network 12. The user can obtain privileges described below in accordance with the given household job point.

As a first example, the user can download software from a website of a manufacturer of a specific home appliance which has been already purchased to the home appliance in accordance with the household job point that the user has, and thus can extend the functionality of the home appliance.

As a second example, the user can purchase a new product of software or hardware prior to general release thereof in accordance with the household job point that the user has.

As a third example, the user can try test use of a new product of software or hardware prior to general release thereof in accordance with the household job point that the user has.

In the embodiment, calculation of a household job point based on the household job data 31 and the manufacturer coefficient information 50 leads to achievement in appropriate giving of a household job point that is commensurate with the household job amount of each user and the manufacturer coefficient.

### First Modification

A first modification may permit a specific user defined in advance to determine or change a manufacturer coefficient. The specific user having a change authority inputs change information indicating a change content of the manufacturer coefficient from a communication device 17 or an integrated controller 16. An acquisition part 201 acquires the change information via a communication network 12. A manufacturer coefficient setting part 204 changes the manufacturer coefficient on the basis of the change information acquired by the acquisition part 201, and stores the changed manufacturer coefficient information 50 in a storage part 112. Thereafter, calculation of a household job point is executed by using the changed manufacturer coefficient information 50.

The specific user may change the manufacturer coefficient of each user unconditionally or within a range in which a total value of manufacturer coefficients of all the users or the household job points for the users reaches an upper limit or lower. For instance, a manufacturer coefficient larger than usual may be set for a user having executed a household job in response to an irregular event, such as a sudden visit of an unexpected visitor. The manufacturer coefficient setting part 204 may set, as the specific user, a user having the largest household job amount within the most recent predetermined period (e.g., one week, one month, or a couple of months) on the basis of the household job data 31 about the predetermined period. A processing part 202 included in an information processing device 11 may transmit a change notification to a communication device 17 owned by a target user whose manufacturer coefficient has been changed to cause the communication device 17 to display, on a screen thereof, such a message as to motivate the user to do the household job.

### Second Modification

In a second modification, a user may not be limited to an individual and may represent a group such as a family. In this case, a manufacturer coefficient setting part 204 sets an identical manufacturer coefficient per group.

### Third Modification

In a third modification, a processing part 202 may calculate a household job point further on the basis of a user coefficient in addition to the manufacturer coefficient.

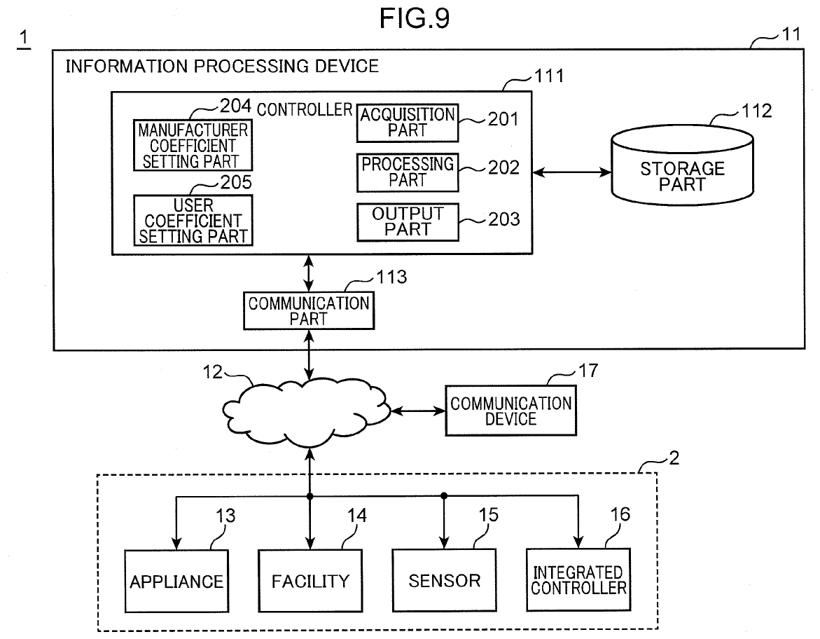

FIG. 9 is a simplified diagram showing an overall configuration of a home control system 1 in the third modification. A controller 111 includes an acquisition part 201, the processing part 202, an output part 203, a manufacturer coefficient setting part 204, and a user coefficient setting part 205. The user coefficient setting part 205 sets a user coefficient for each of a plurality of users to create user coefficient information 51, and stores the created user coefficient information 51 in a storage part 112.

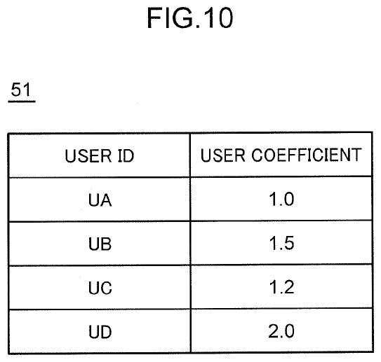

FIG. 10 is a table showing an example of simplified user coefficient information 51. In the example shown in FIG. 10, user coefficients “1.0”, “1.5”, “1.2”, and “2.0” are set respectively for users UA, UB, UC, and UD. The user coefficient setting part 205 sets the user coefficient information 51 in advance. The user coefficient setting part 205 sets the user coefficient information 51 on the basis of, for example, household job data 31, 32 about a plurality of users in a predetermined period. As a first example, the user coefficient setting part 205 may set a larger user coefficient for a user having a larger household job amount within the most recent one month in accordance with a household job amount. This attains an improvement in a motivation of a user having a larger household job amount. As a second example, the user coefficient setting part 205 may set a larger user coefficient for a user having a smaller household job amount within the most recent one month in accordance with a household job amount. This attains an improvement in a motivation of a user having a smaller household job amount. Here, all the users may have different user coefficient values from each other, or a part of the users may have an identical user coefficient value.

The processing part 202 multiplies the manufacturer coefficient shown in FIG. 7 and the user coefficient shown in FIG. 10 by the household job point included in the household job point information 41 shown in FIG. 6 to calculate the household job point for each user.

### Fourth Modification

In a fourth modification, a processing part 202 may calculate a household job point further on the basis of an attribute coefficient in addition to the manufacturer coefficient.

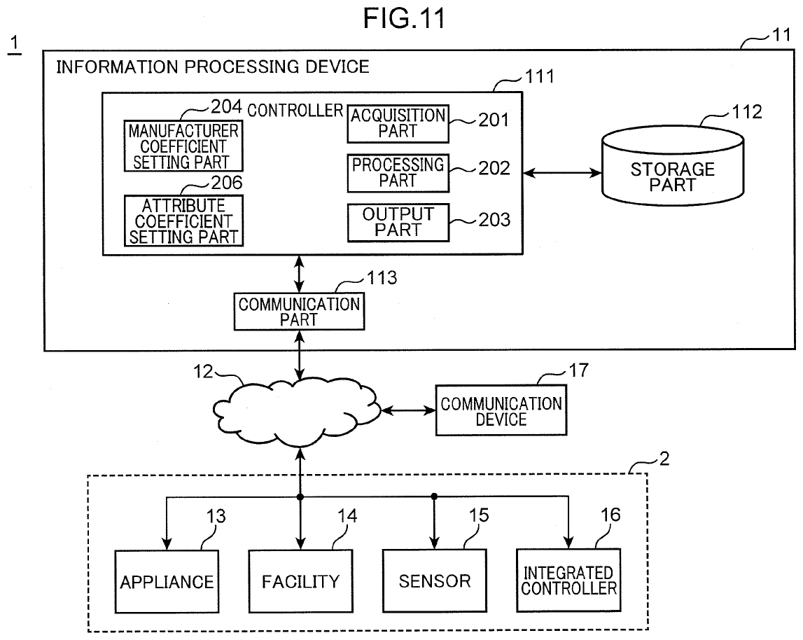

FIG. 11 is a simplified diagram showing an overall configuration of a home control system 1 in a fourth modification. A controller 111 includes an acquisition part 201, the processing part 202, an output part 203, a manufacturer coefficient setting part 204, and an attribute coefficient setting part 206. The attribute coefficient setting part 206 sets an attribute coefficient for each of a plurality of different kinds of attributes to create attribute coefficient information 52, and stores the created attribute coefficient information 52 in a storage part 112.

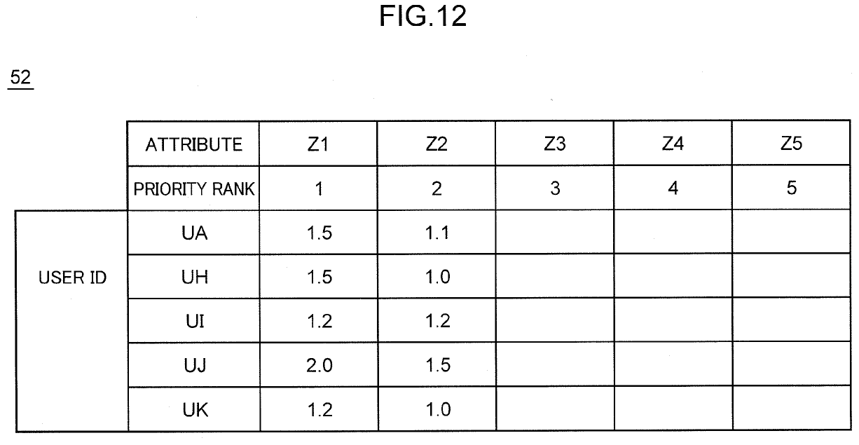

FIG. 12 is a table showing an example of simplified attribute coefficient information 52. The attribute coefficient information 52 includes a plurality of different kinds of attributes Z1 to Z5. Each of the attributes Z1 to Z5 has a priority rank. The kinds of attributes include a gender, an age, a generation, a weekly day off, a family configuration, a hobby, or a residential area. For instance, the kind of attribute Z1 indicates the generation, and the generation includes a plurality of categories of teens or lower, twenties, thirties, forties, fifties, and sixties or higher. FIG. 12 shows attribute coefficients respectively for users UA, UH, UI, UJ, and UK belonging to the same category of the generation. In this example, attribute coefficients “1.5”, “1.5”, “1.2”, “2.0”, and “1.2” are set respectively for the users UA, UH, UI, UJ, and UK. The attribute coefficient setting part 206 sets the attribute coefficient information 52 in advance. The attribute coefficient setting part 206 sets the attribute coefficient information 52 on the basis of, for example, household job data 31, 32 about a plurality of users in a predetermined period. As a first example, the attribute coefficient setting part 206 may set a larger attribute coefficient for a user having a larger household job amount within the most recent one month in accordance with a household job amount. This attains an improvement in a motivation of a user having a larger household job amount. As a second example, the attribute coefficient setting part 206 may set a larger attribute coefficient for a user having a smaller household job amount within the most recent one month in accordance with a household job amount. This attains an improvement in a motivation of a user having a smaller household job amount. Here, all the users may have different attribute coefficient values from each other, or a part of the users may have an identical attribute coefficient value.

The attribute coefficient setting part 206 may set the attribute coefficient for each category of the plurality of categories included in the attribute. In this case, the attribute coefficient setting part 206 sets an identical attribute coefficient for the users belonging to the same category. For instance, regarding the attribute Z1 of the generation, the attribute coefficient is set for each age range, and an identical attribute coefficient is set for users belonging to the same age range. The attribute coefficient setting part 206 may set a larger attribute coefficient for an age range having a larger average value of household job amounts in a collecting period, or may set a larger attribute coefficient for an age range having a smaller average value of household job amounts in the collecting period. The attribute coefficient setting part 206 selects, in accordance with a kind of attribute, either a first way of setting different attribute coefficients among users belonging to the same category or a second way of setting different attribute coefficients among a plurality of categories included in an attribute. Information about the selection is included in the attribute coefficient information 52. The first way is selected in connection with the weekly day off, the family configuration, or the hobby, and the second way is selected in connection with the gender, the age, the generation, or the residential area.

The processing part 202 multiplies the manufacturer coefficient shown in FIG. 7 and the attribute coefficient shown in FIG. 12 by the household job point included in the household job point information 41 shown in FIG. 6 to calculate the household job point for each user. The processing part 202 may multiply the manufacturer coefficient shown in FIG. 7, the user coefficient shown in FIG. 10, and the attribute coefficient shown in FIG. 12 by the household job point included in the household job point information 41 shown in FIG. 6 to calculate the household job point for each user.

The present disclosure is particularly useful for a home control system including a smart home adopting the IoT technologies.

1. A household job point calculation method, comprising:
by an information processing device,
acquiring use information indicating a use situation of an appliance or a facility;
collecting household job data of a user on the basis of the use information;
acquiring third party coefficient information indicating a third party coefficient set by a third party different from the user; and
calculating, on the basis of the household job data and the third party coefficient information, a household job point that is commensurate with a household job amount of the user.

2. The household job point calculation method according to claim 1, wherein the third party includes a manufacturer of an appliance or a facility.

3. The household job point calculation method according to claim 2, further comprising setting a third party coefficient for a user who uses an appliance or a facility manufactured by a specific manufacturer to be larger than a third party coefficient for a user who uses an appliance or a facility manufactured by another manufacturer.

4. The household job point calculation method according to claim 2, further comprising setting a third party coefficient for a user who uses a first number of appliances or facilities manufactured by the specific manufacturer to be larger than a third party coefficient for a user who uses a second number of appliances or facilities manufactured by the specific manufacturer, the second number being smaller than the first number.

5. The household job point calculation method according to claim 2, further comprising setting a third party coefficient for a user who uses an appliance or a facility manufactured by the specific manufacturer on a first manufacture date to be larger than a third party coefficient for a user who uses an appliance or a facility manufactured by the specific manufacturer on a second manufacture date earlier than the first manufacture date.

6. The household job point calculation method according to claim 1, further comprising:
acquiring user coefficient information indicating a user coefficient for a user; and
calculating the household job point on the basis of the household job data, the third party coefficient information, and the user coefficient information.

7. The household job point calculation method according to claim 1, further comprising:
acquiring attribute coefficient information indicating an attribute coefficient in connection with an attribute of a user; and
calculating the household job point on the basis of the household job data, the third party coefficient information, and the attribute coefficient information.

8. The household job point calculation method according to claim 1, further comprising:
acquiring, from a specific user, change information indicating a change in the third party coefficient; and
changing the third party coefficient on the basis of the change information.

9. The household job point calculation method according to claim 8, further comprising setting the specific user on the basis of household job data of a plurality of users in a predetermined period.

10. An information processing device, comprising:
an acquisition part; and
a processing part, wherein
the acquisition part acquires use information indicating a use situation of an appliance or a facility,
the processing part collects household job data of a user on the basis of the use information,
the acquisition part acquires third party coefficient information indicating a third party coefficient set by a third party different from the user, and
the processing part calculates, on the basis of the household job data and the third party coefficient information, a household job point that is commensurate with a household job amount of the user.

11. A computer-readable recording medium recording a program causing an information processing device to serve as an acquisition part and a processing part, wherein
the acquisition part acquires use information indicating a use situation of an appliance or a facility,
the processing part collects household job data of a user on the basis of the use information,
the acquisition part acquires third party coefficient information indicating a third party coefficient set by a third party different from a user, and
the processing part calculates, on the basis of the household job data and the third party coefficient information, a household job point that is commensurate with a household job amount of the user.
